(19) United States
(12) Patent Application Publication
(10) Pub. No.: US 2026/0099725 A1
(43) Pub. Date: Apr. 9, 2026

(54) TOPOLOGICAL SPARSE TRAINING PROCESS FOR MACHINE LEARNING MODELS

(71) Applicant: International Business Machines Corporation, Armonk, NY (US)

(72) Inventors: Amit Dhurandhar, YORKTOWN HEIGHTS, NY (US); Soham Dan, YORKTOWN HEIGHTS, NY (US); Aurelie Chloe Lozano, YORKTOWN HEIGHTS, NY (US); Georgios Kollias, YORKTOWN HEIGHTS, NY (US); Ronny Luss, YORKTOWN HEIGHTS, NY (US); Payel Das, YORKTOWN HEIGHTS, NY (US); Tejaswini Pedapati, YORKTOWN HEIGHTS, NY (US)

(21) Appl. No.: 18/906,079

(22) Filed: Oct. 3, 2024

(51) Int. Cl. G06N 3/096; G06N 3/0475

(52) U.S. Cl. CPC G06N 3/096; G06N 3/0475

(57) ABSTRACT

An example operation may include one or more of executing a machine learning (ML) model with a plurality of attention heads on a training data input during an epoch to generate a predicted output, determining a difference between the predicted output an and actual output corresponding to the training data input based on a loss function that is configured to perform preferential attachment of neurons in the ML model, modifying parameter values of the ML model based on the difference, wherein the modifying comprises modifying at least one parameter value of the parameter values of the ML model to be set to zero to generate a sparse ML model, and executing the sparse ML model on an additional training data input during an additional epoch to generate an additional predicted output.

### BACKGROUND

Transformer-based machine learning (ML) models leveraging attention mechanisms have led to improved performance on natural language processing (NLP) tasks and other multimodal applications, in both classification and generation settings. The transformer-based ML models are often referred to as large language models (LLMs). Despite the performance improvements, the computational overhead required for training, and inference, hinders progress. The models are large and are typically parameterized by many dense matrices, which require significant processing for training and inference, and significant storage space for storing the model.

### SUMMARY

One example embodiment provides a computer-implemented method that may include one or more of executing a machine learning (ML) model with a plurality of attention heads on a training data input during an epoch to generate a predicted output, determining a difference between the predicted output and an actual output corresponding to the training data input based on a loss function that is configured to perform preferential attachment of neurons in the ML model, modifying parameter values of the ML model based on the difference, wherein the modifying comprises modifying at least one parameter value of the parameter values of the ML model to be set to zero to generate a sparse ML model, and executing the sparse ML model on an additional training data input during an additional epoch to generate an additional predicted output.

Another example embodiment provides a computer system that may include one or more of a processor set, a set of one or more computer-readable storage media, and program instructions, collectively stored in the set of one or more storage media, for causing the processor set to perform computer operations comprising execute a machine learning (ML) model with a plurality of attention heads on a training data input in the course of an epoch to generate a predicted output, determine a difference between the predicted output and an actual output corresponding to the training data input based on a loss function that is configured to perform preferential attachment of neurons in the ML model, modifying parameter values of the ML model based on the difference, wherein the modifying comprises modify at least one parameter value of the parameter values of the ML model to be set to zero to generate a sparse ML model, and execute the sparse ML model on an additional training data input in the course of an additional epoch to generate an additional predicted output.

A further example embodiment provides a computer program product that may include one or more of a set of one or more computer-readable storage media, and program instructions, collectively stored in the set of one or more computer-readable storage media, for causing a processor set to perform computer operations comprising executing a machine learning (ML) model with a plurality of attention heads on a training data input during an epoch to generate a predicted output, determining a difference between the predicted output and an actual output corresponding to the training data input based on a loss function that is configured to perform preferential attachment of neurons in the ML model, modifying parameter values of the ML model based on the difference, wherein the modifying comprises modifying at least one parameter value of the parameter values of the ML model to be set to zero to generate a sparse ML model, and executing the sparse ML model on an additional training data input during an additional epoch to generate an additional predicted output.

### BRIEF DESCRIPTION OF THE DRAWINGS

FIG. 1 is a diagram illustrating a computing environment according to an embodiment of the instant solution.

FIG. 2A is a diagram illustrating a system for training a sparse ML model according to the examples and features of the instant solution.

FIG. 2B is a diagram illustrating a process of preferential attachment performed on nodes within a ML model according to the examples and features of the instant solution.

FIG. 2C is a diagram illustrating a process of eliminating redundant attention heads from a ML model according to the examples and features of the instant solution.

FIG. 2D is a diagram illustrating an algorithm for end-to-end training a sparse ML model according to the examples of features of the instant solution.

FIG. 2E is a diagram illustrating an algorithm for preferential attachment of neurons within a ML model according to the examples of features of the instant solution.

FIG. 2F is a diagram illustrating an algorithm for removing redundant attention heads from a ML model according to the examples of features of the instant solution.

FIG. 3A is a diagram illustrating integration of an AI model into any decision point according to the examples and features of the instant solution.

FIG. 3B is a diagram illustrating a process for developing an AI model that supports AI-assisted computer decision points according to the examples and features of the instant solution.

FIG. 3C is a diagram illustrating a process for utilizing an AI model that supports AI-assisted computer decision points according to examples and features of the instant solution.

FIG. 4A is a diagram illustrating a flow diagram, according to example embodiments.

FIG. 4B is a diagram illustrating a flow diagram, according to example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

Transformer-based machine learning models (e.g., large language models, etc.) have become ubiquitous in natural language processing (NLP) due to their impressive performance on various tasks. While enforcing sparsity at various levels of the model architecture has found promise in addressing scaling and efficiency issues, there remains a disconnect between how sparsity affects network topology.

Inspired by brain neuronal networks, the example embodiments are directed to a model training process that results in a machine learning model (e.g., large language model, etc.) with sparsity using preferential attachment and redundant attention head pruning. The training process generates a model that is principled, and model-agnostic sparsity. Furthermore, the training creates a model that is performant and efficient across diverse NLP tasks, spanning both classification (such as natural language inference) and generation (summarization, machine translation), despite the sole objective not being optimizing performance. The training process is competitive with (or sometimes superior to) baselines on performance and can be exceedingly faster in terms of training time for a given level of sparsity, simultaneously exhibiting measurable improvements in inference time in many cases.

In the example embodiments, network topologies can be exploited in transformer-based large language models (LLMs) to offer sparser models (in terms of fewer parameters and fewer attention heads overall) while maintaining performance (e.g., accuracy) of the model. The framework described herein is model-agnostic as well as task-agnostic and is a dynamic sparse training method inspired by biological neuronal networks present in the brain. For example, there are two stages by which connections (synapses) in a neuronal network evolve in the brain. First, an over-abundance of synapses is created, which is similar to the pretraining of an LLM. In the second stage, synapses are judiciously removed until stability in the network is achieved, which is akin to finetuning an LLM for a particular task by inducing sparsity, or at a higher level, by removing attention heads. The framework described herein provides sparsity within the Multi-Layer Perceptron (MLP) layers and the attention heads, through a combination of preferential attachment among neurons in the network and the elimination of redundant attention heads.

Preferential attachment inspired regularization within MLP layers and attention heads is motivated by a network concept which is found to be highly relevant in neuronal networks in the brain, namely that over time, neurons with more connections build even more connections, while those with fewer connections are removed. Similarly, the framework herein induces weighted sparsity in MLP layers (weight is inverse to connectivity/degree) and group sparsity within attention heads, so that influential neurons (measured by attention parameters) are maintained while those with little influence are pruned. Modeling the removal of weak synapses is an established approach to understanding the refinement process of neurons in the brain. For LLMs, weights of less-connected neurons are removed or “zeroed” through the parameter matrices of the LLM by zeroing out parameter values of entire rows in attention and MLP layers.

While structured sparsity provided by the framework aims at preferential attachment, such pruning (by zeroing out weights) cannot determine which connections are redundant. Elimination of redundant connections is an important aspect of the refinement process that takes place after the brain develops very dense networks of connections. In the example embodiments, redundancy can be measured by similarity between attention heads (e.g., similarity between QKV matrices, etc.) whereupon similar attention heads can then be merged, resulting in reduced complexity while maintaining functionality (i.e., performance is maintained on downstream tasks).

The example embodiments are integrated into a model training process which results in custom attention and MLP (structured) sparsity regularizations based on preferential attachment, and a novel redundancy-based head pruning scheme. The training process has numerous benefits, including that the training is task agnostic, and that it is easily adaptable to different transformer-based LLM architectures as it does not add additional mask variables to do the pruning. Furthermore, the process learns sparsity patterns exhibiting principled topological structure. The training results in LLMs with a competitive and even sometimes superior performance on different benchmarks and tasks (GLUE, summarization, machine translation), although the described embodiments may be more neuroscience-motivated than solely trying to maximize performance. The training process is generally much faster than the competing baselines, with time per epoch being similar to standard fine-tuning. The trained model also exhibits faster inference processing as the topological constraints encourage N: M-type sparsity.

A Transformer includes multiple identical units. Each unit in turn is comprised of a Multi-Head Attention (MHA) Layer and a Feed Forward (FFN) or MLP Layer (used interchangeably). Each attention layer is partitioned into multiple heads Hᵢ composed of Query Q_{H}_{_{I}}, Key K_{H}_{ᵢ} and Value V_{H}_{ᵢ} parameter matrices. An MHA layer with k heads computes the attention of all heads in parallel and concatenates them. The FFN layer in turn has two linear layers, one to expand the dimensions and the other to project it back to the original dimension.

The example embodiments include sparsification of a transformer block of an LLM at three levels: i) two Multi-Layer Perceptron (MLP) layers (an expansion layer and a contraction layer), ii) the attention layers, and iii) head pruning at the level of attention layers. The process can be performed based on a sequence of steps. For example, the input to the algorithm may be the pre-trained model, dataset, sparsity parameters α, β≥0, number of epochs, a loss function λ, and a redundancy threshold θ. The system may fine tune the model on the given dataset for the number of epochs using stochastic gradient descent with cross-entropy loss λ and two regularizations weighted with α and β, respectively. The first regularization penalizes rows of the attention matrices QKV concatenated to be zero for each layer. The second regularization penalizes the connection of the neurons in the MLP portion of the transformer where sparser neurons are penalized (more) proportional to their sparsity to obtain a preferentially attached topology. After each epoch of training, the redundant attention heads in each layer are removed where two heads are considered similar if the L infinity distance between them is less than or equal to the redundancy threshold θ. The L infinity distance between attention heads measures the maximum absolute difference between their corresponding elements. The L infinity distance quantifies how different two attention heads are by determining the largest difference in their attention parameters across all positions.

The process also includes two sub-procedures. In a first sub-procedure, the attention heads in a layer and the redundancy threshold θ are input to the system, and pairs of attention heads that have 1 infinity distances between their QKV concatenated matrix which is less than or equal to are found. The system can then find dominating heads, i.e., heads that are similar to many heads and reduce them by replacing some of the heads and keeping the most dominant head. Here, the system can keep the dominating heads, removing all other heads and adjusting weights of the output dense layer.

In a second sub-procedure, the system can find an attention head that is similar to all heads the current head is similar to. The system can mark this head as dominating the current head if it is similar to a strict superset of heads or if it is similar to the same heads but is a later head. A later head refers to a head that is in a further downstream position with respect to a flow of information through the transformer. Furthermore, the system can perform this second sub-procedure for all heads in a layer.

In the example embodiments, during training of an LLM, a weighted 11 penalty is added to the training objective in each transformer layer, where the weights for each row of entries in the matrix are inversely proportional to the (fractional) connectivity of that neuron. Specifically, the system penalizes neurons with less connectivity more than the densely connected ones. This explicitly encourages preferential attachment, yielding a training process where sparsely connected neurons are likely to be weeded out. Rather than adding extra masking variables to implement preferential behavior, the system can leverage group sparsity and apply a penalty on the rows of [Q, K, V], where p=1 and q=0.5. The penalty may be more robust to other choices as it leads to a sharp reduction in the parameter values belonging to a group.

The above constraint is applied across heads in the attention layer as it considers the entire Q, K, V matrices (hence the inner summation over 3d entries). Additionally, while the standard group penalty induces weights within a group to be similar, this group penalty allows sparsity patterns to be learned within a group. For example, while entire rows are often removed, the process may also observe that certain rows only exhibit sparsity in Q and K while leaving corresponding rows of V dense, which is still valuable as it indicates that attention may not be required for those neurons/dimensions. A penalty encourages sparse rows to become more sparse as the penalty tries to eliminate those rows by making them zero, e.g., substantially zero (almost zero), which again showcases preferential behavior.

Meanwhile, head pruning of the attention heads may be performed after each epoch of the training process. For example, the system may remove heads in a layer that are similar to other heads and are hence deemed redundant. For example, the system may remove as many heads as possible in order to get maximum sparsification. The system described herein accomplishes this by determining which heads are similar to many other heads (e.g., are similar to at least two other heads and/or are similar to a certain number of other heads that is greater than a threshold level), and then maintaining such heads while removing others. Note that similarity is not transitive, and thus removal of heads is not trivial. The system removes an attention head that is dominated by another head, i.e., the dominated head is similar to only a subset of heads that the dominating head is similar to. The problem of keeping a minimum number of heads based on similarity can be mapped to the dominating set problem, where each head is a vertex, and each edge indicates being similar. The system can find the minimum number of vertices such that they, along with their adjacent vertices, account for all the vertices in the graph.

The process is NP-Hard, and the pruning relies on a quadratic-time approximation to solve this, where the pruning biases towards keeping latter heads in a layer. Here, the algorithm also biases towards keeping vertices (heads) with high degrees, which elicits preferential behavior.

The system for training a sparse model that is described herein may be implemented within a software application, a service, or the like, which may be hosted by a host platform such as a cloud platform, a web server, a database, or the like.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, except for limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

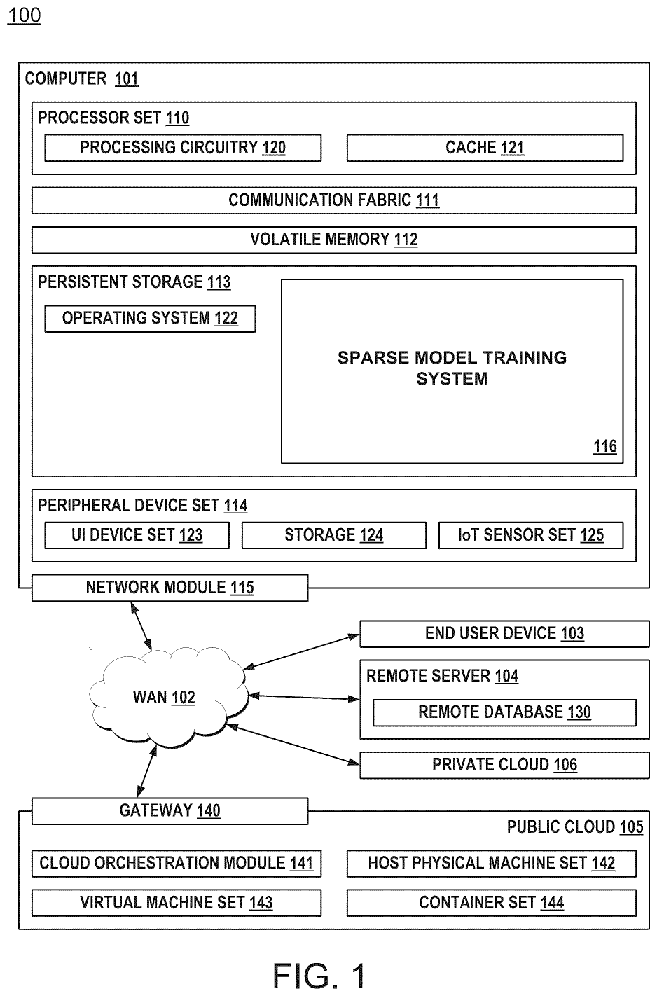

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as sparse model training system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

The example embodiments are directed to a framework that executes a dynamic sparse training process for neural network models, such as large language models, which leads to structured sparse models that are fast to train, accurate and which perform inferences faster than a non-sparse neural network model. The training process is task agnostic and easily transferable to multiple transformer-based architectures. The sparsity is created in two ways. First, neurons within the network are removed (weighted to zero) through the iterative training process which penalizes neurons that have less connections (weak connections) to other neurons within the network and rewards neurons that are highly connected to other neurons. Second, redundant attention heads (i.e., attention heads which are mostly performed by another attention head) are identified and removed. Both steps can reduce the size of the neural network and increase the processing speed of a computing system when executing the neural network.

The penalty (reduced weight) on neurons is created by a loss function that includes a penalizing function that decreases the weight of neurons (parameters) within the model that have fewer connections and increases the weight of neurons within the model which have more connections. Furthermore, the training process can maintain and learn new connections in a topologically guided manner. That is, the system enforces and reuses the learned connections between neurons as much as possible before activating new connections to other neurons. Furthermore, the system may add new connections preferably close to many active connections. Meanwhile, the system also aims to keep as few attention heads/layers as possible.

The system can understand/derive what sparsifications in the Q, K and V matrices correspond to semantically meaningful sparsifications in terms of token embeddings and token-token interactions. The framework may abstract out nodes (neurons) and connections (synapses) for transformers. The framework may motivate what “neighboring connections” means for transformers. This includes identifying what a neuron would correspond to in the attention layers and then determining how to sparsify its connections. The framework also performs preferential attachment for the MLP layers where neurons with fewer connections get sparser and sparser. For MLP, the framework may apply a weighted L1 penalty where for sparser neurons the weight is proportional to the sparsity. Meanwhile, for attention, the framework may apply group sparsity penalty on rows of the attention matrix encouraging entire dimensions to be eliminated.

Some of the benefits of the example embodiments include that the framework is easy to adapt to different transformer-based architectures (encoder, encoder-decoder and decoder) as no architectural changes have to be made unlike other approaches (e.g., CoFi and DSP). The training process is also task agnostic. Here, the framework learns sparsity patterns in a topologically principled neuro-inspired manner. The sparse model that results is mostly superior to other baselines in performance. The model is also much faster to train than competitors and exhibits improved/faster inference time.

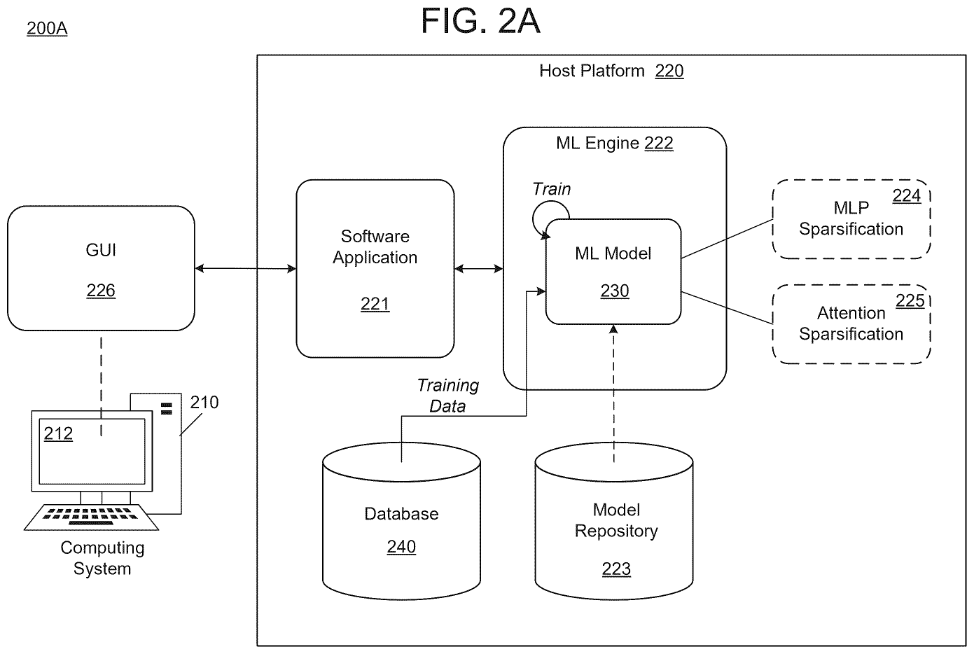

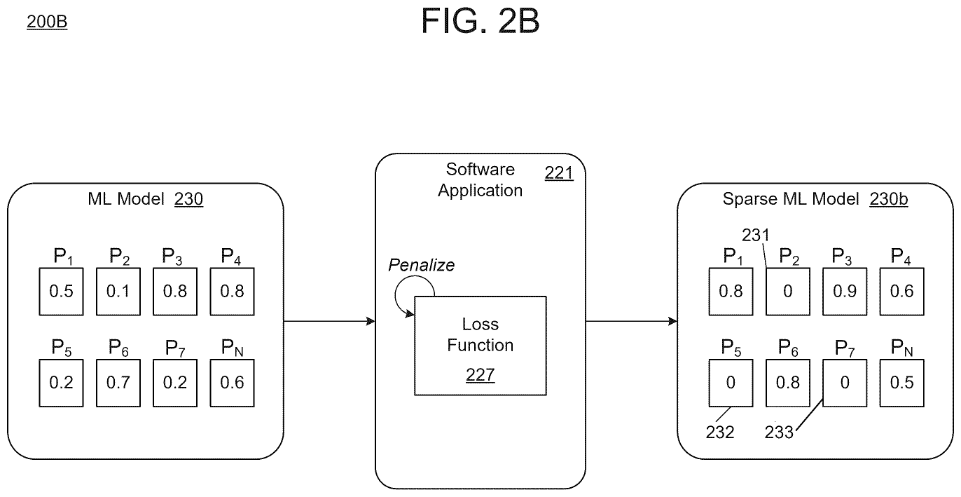

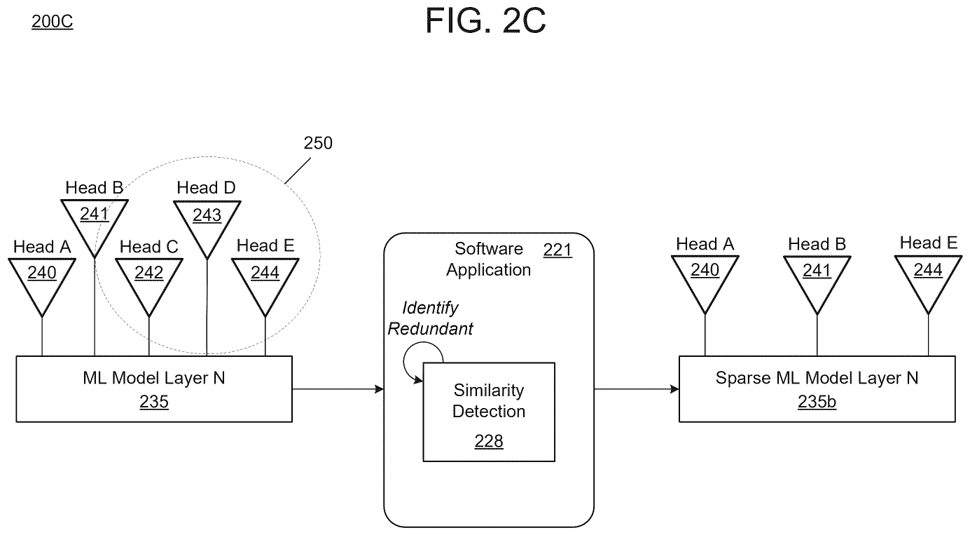

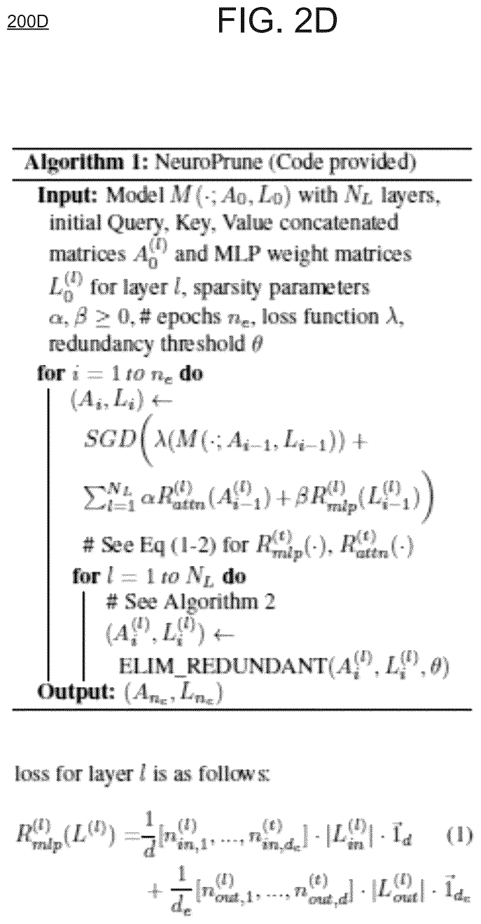

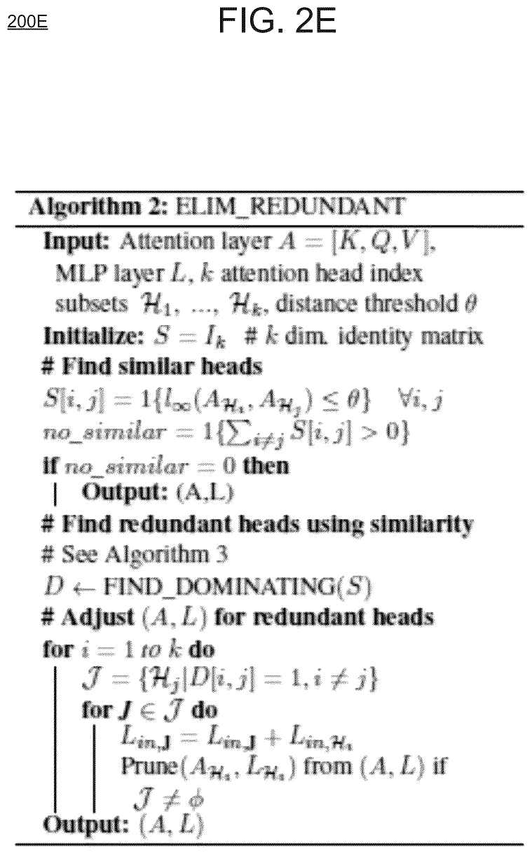

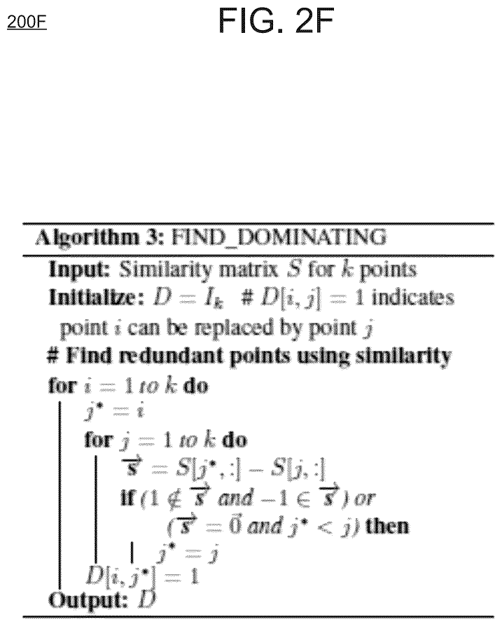

FIG. 2A illustrates a system 200A for training a sparse ML model according to the examples and features of the instant solution. Referring to FIG. 2A, the framework described herein may be implemented within a software application 221 that is hosted by a host platform 220. The host platform 220 may be a cloud platform, a web server, a database, a combination of systems, and the like. The host platform 220 may also host a machine learning (ML) engine 222 that can execute, train, develop, etc. machine learning models, artificial intelligence models, and the like. The models may be held within a model repository 223.

In this example, a user may connect to the host platform 220 using a computing system 210. For example, the computing system 210 may be a personal computer, laptop computer, server, etc., which includes a display device 212. The computing system 210 may connect to the host platform 220 over a computer network such as the Internet. Here, the software application 221 may be a progressive web application, however, embodiments are not limited thereto. The computing system 210 may access the software application 221 may entering an IP address of the software application 221 into a web browser (not shown) installed on the computing system 210.

The software application 221 may also provide a graphical user interface (GUI) 226 which includes a development environment for developing and training models. The GUI 226 may be displayed on the display device 212 of the computing system 210 by the software application 221 when the computing system 210 connects to the software application 221.

According to various embodiments, the user may trigger a training process by the software application 221 based on inputs that are provided through the GUI 226 which are then sent to the software application 221. In response, the software application 221 may control a machine learning (ML) model 230 that is pulled from the model repository 223 (or created from scratch) and loaded into the ML engine 222. Here, the software application 221 may perform a training process for the ML model 230. As an example, the software application 221 may run one or more scripts which cause training data to be fetched from a database 240 and input to the ML model 230. The training data may be table data that is pulled from the database 240 by a script and input to the ML model 230. During training, a combination of MLP sparsification 224 and attention sparsification 225 may be performed. An example of MLP sparsification 224 is shown and described with respect to FIG. 2B, and an example of attention sparsification 225 is shown and described with respect to FIG. 2C.

During the training, the ML model 230 may receive the input data and generate an output (prediction). The process may be iteratively repeated for multiple training epochs. Each epoch may include an additional training input being fetched by the script and input to the ML model 230, and an additional output being created. Furthermore, each epoch may include a backpropagation step and a feed forward step. During backpropagation, the predicted output is compared to the actual output that corresponds to the target input data. The loss function is used to quantify the difference between the prediction and a ground truth value that is part of the training data. During feed forward, the parameters of the neural network are modified/updated based on the difference.

According to various embodiments, the loss function described herein penalizes parameters of nodes/neurons that are less connected in the network and rewards nodes that are more connected in the network. The penalty may be a reduced weight while the reward may be an increased weight or keeping a weight the same. By penalizing the parameter values corresponding to the less connected nodes in the network, the weight of the less connected nodes eventually becomes zero thereby removing the parameter from the model. Furthermore, the QKV matrices of the different attention heads may be compared to each other to determine attention heads that are similar enough to each other (within a threshold) that they are considered redundant. The redundant heads can be reduced, for example, by removing at least one of the redundant heads to create a sparse model.

FIG. 2B illustrates a process 200B of preferential attachment performed on nodes within a ML model according to the examples and features of the instant solution. The process 200B shown in FIG. 2B may be an iterative process that modifies parameter values of the different parameters of the ML model 230 during each iteration. Referring to FIG. 2B, each epoch/iteration of the training process includes a loss function 227 being applied by the software application 221 to determine the difference between the prediction and a ground truth value. The resulting difference is then used to modify parameter values of the model.

In this example, the loss function 227 that is applied during the backpropagation process may penalize the parameters corresponding to nodes that are less connected (less than a threshold number of connections) and reward nodes that are more connected. The result is that nodes that are less connected are weighted down to zero resulting in parameter being removed from influencing the prediction made by the ML model 230. Here, the loss function 227 iteratively penalizes parameter values 231, 232, and 233 such that the parameter values 231, 232, and 233 eventually become zero as shown in the difference between the parameter values in the ML model 230 and the sparse ML model 230b.

FIG. 2C illustrates a process 200C of eliminating redundant attention heads from the ML model 230 according to the examples and features of the instant solution. Referring to FIG. 2C, the ML model 230 includes multiple layers of nodes. Each layer includes multiple attention heads (the same attention heads). Here, a layer 235 of the ML model 230 is shown with attention heads 241, 242, 243, 244, and 245. According to various embodiments, the software application 221 may include a similarity detection 228 that compares the QKV matrices of each of the attention heads 241, 242, 243, 244, and 245, and can identify attention heads with QKV matrices that are similar enough to be within a threshold of similarity. In such cases, the software application 221 determines the attention heads are redundant, and removes one of the attention heads.

The decision on which attention head to remove can be determined based on which head is “dominated” by the other head. The dominating head will have greater functionality than the dominated head. In the example of FIG. 2C, the software application 221 identifies 250 that attention heads 242, 243, and 244 are considered redundant, and attention head 244 is identified as the dominant head. Accordingly, the software application 221 may remove attention heads 242 and 243 from the layer 235 (and from each of the layers of the ML model 230) resulting in a sparse layer 235b. This same process may be repeated for each of the layers of the ML model resulting in significantly less size.

It should be appreciated that the process 200B shown in FIG. 2B and the process 200C shown in FIG. 2C may be performed simultaneously or at different times.

Detailed descriptions of training an artificial intelligence (AI) model and executing the AI model are further described and depicted herein. For example, the AI model may include a large language model (LLM), or the like.

FIG. 2D illustrates an algorithm 200D for end-to-end training a sparse ML model according to the examples of features of the instant solution. Referring to FIG. 2D, preferential sparsification of the MLP layers is conceptually the simplest component of the system described herein. In the algorithm 200D, for each Lᵢₙ and Lₒᵤₜ matrix in each Transformer layer, a weighted l₁ penalty is added to the training objective, where the weights for each row of entries in the matrix are inversely proportional to the (fractional) connectivity of that neuron. Specifically, let n_{in,i} be the number of entries in the i^{th} row of Lᵢₙ with absolute values less than some small ϵ>0 (with n_{out,i} similarly defined for Lₒᵤₜ). The MLP regularizer added to the training loss for layer 1 is shown at the bottom of the diagram. Here, the ‘.’ denotes an element-wise absolute value and \vec{l}_{d} is a d-dimensional vector of 1s. In essence, Equation (1) penalizes neurons with less connectivity more than the densely connected ones. This explicitly encourages preferential attachment, yielding a training process where sparsely connected neurons are likely to be weeded out.

FIG. 2E illustrates an algorithm 200E for preferential attachment of neurons within a ML model according to the examples of features of the instant solution. The algorithm 200E may be a sub-procedure that is part of the algorithm 200D shown in FIG. 2D. Referring to FIG. 2E, it is not obvious what topological sparsity based on preferential attachment would entail for attention. The system described herein can perform a novel process for inducing such sparsity as shown in FIG. 2E.

Considering the connectivity of an input embed-ding neuron to the output neurons of an attention layer, it is evident that the i^{th} embedding dimension only interacts with the i^{th} row of the Q, K and V matrices. These interactions can be visualized as connections to the output neurons. However, even one non-zero entry in the i^{th} row of Q, K, V leads to the i^{th} input neuron being connected to all output neurons. Hence, to remove the effect of this neuron on the output neurons, one needs to zero out the i^{th} row in all three matrices. In other words, a group sparsity penalty, where each group is a row of the concatenated A=[Q, K, V] matrix, is desired. Such a penalty encourages sparse rows to become more sparse as it tries to eliminate those rows by making them (almost) zero, again showcasing preferential behavior.

Rather than adding extra masking variables to implement preferential behavior, the process may leverage group sparsity and apply an 14 norm penalty on the rows of [Q, K, V], where p=1 and q=0.5. The l^{.5} penalty was seen to be more robust to other choices in as it leads to a sharp reduction in the parameter values belonging to a group. As such the following regularization, corresponding to the attention matrix at layer I can be added to the training loss, where A^{(l)} is the concatenated QKV matrix:

$${R}_{attn}^{( l )} ( {A}^{( l )} ) = {\sum }_{i = 1}^{d} \sqrt{{\sum }_{j = 1}^{3 d} \vert {A}_{ij}^{( l )} \vert}$$

Note that the above constraint is applied across heads in the attention layer as it considers the entire Q, K, V matrices (hence the inner summation over 3d entries). Additionally, while the standard l₂ group penalty induces weights within a group to be similar, this l^{.5} group penalty allows sparsity patterns to be learned within a group. For example, in FIGS. 1 and 8, while entire rows are often removed, it can also be observed that certain rows only exhibit sparsity in Q and K while leaving corresponding rows of V dense, which is still valuable as it indicates that attention may not be required for those neurons/dimensions.

FIG. 2F illustrates an algorithm 200F for removing redundant attention heads from a ML model according to the examples of features of the instant solution. The algorithm 200F may be a sub-procedure that is part of the algorithm 200D shown in FIG. 2D. Referring to FIG. 2F, unlike the attention and MLP sparsifications mentioned above, head pruning is done after each epoch as seen in the algorithm 200D. The main idea here is to remove heads in a layer that are similar to other heads and are hence deemed redundant. The process can remove as many heads as possible in order to get maximum sparsification. The system accomplishes this by determining which heads are similar to many other heads, and then maintaining such heads while removing others. Note that similarity is not transitive, and thus removal of heads is not trivial.

In this example, the system can remove heads that are dominated by other heads, i.e., the dominated head is similar to only a subset of heads that the dominating head is similar to. The problem of keeping a minimum number of heads based on similarity can be mapped to the dominating set problem, where each head is a vertex and each edge indicates being similar. Here, the system can find the minimum number of vertices such that they, along with their adjacent vertices, account for all the vertices in the graph. This problem is NP-Hard and the approach (detailed in the algorithm 200F) is a quadratic-time approximation to solve this, where it biases towards keeping latter heads in a layer. Since the algorithm also biases towards keeping vertices (heads) with high degrees, the head pruning scheme also elicits preferential behavior. An important note to make is that, unlike related methods, the process does not prune according to head importance, but rather head redundancy, and hence even important heads can get pruned. The experiments indeed show that the average head importance is quite high across the heads that get eliminated. This can lead to more aggressive pruning and faster train times as witnessed in conducted experiments.

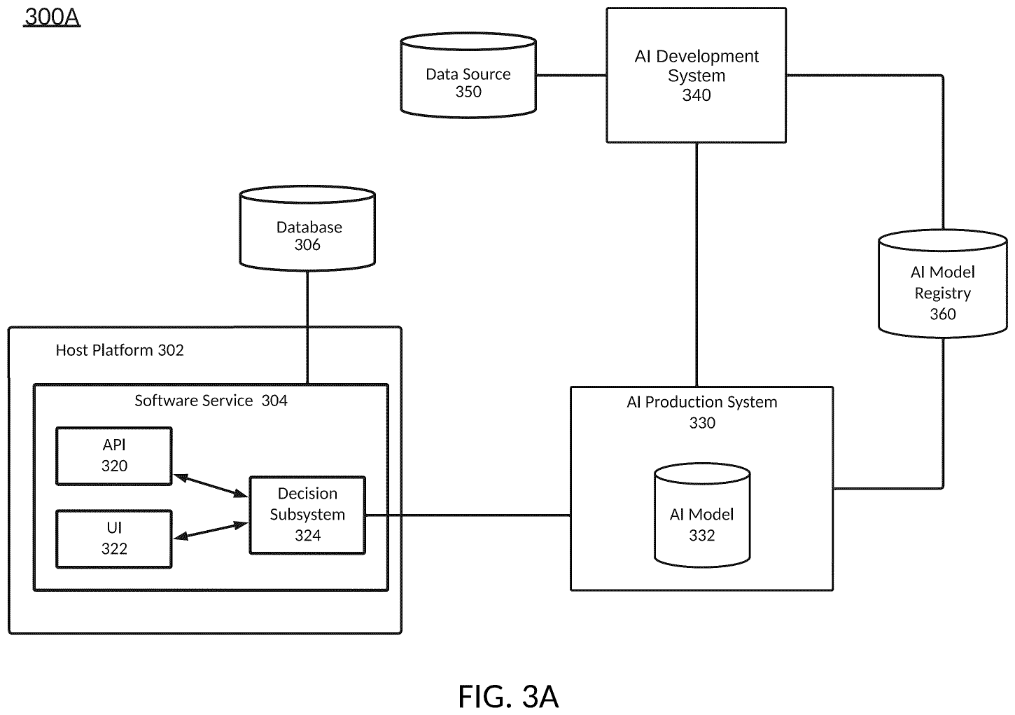

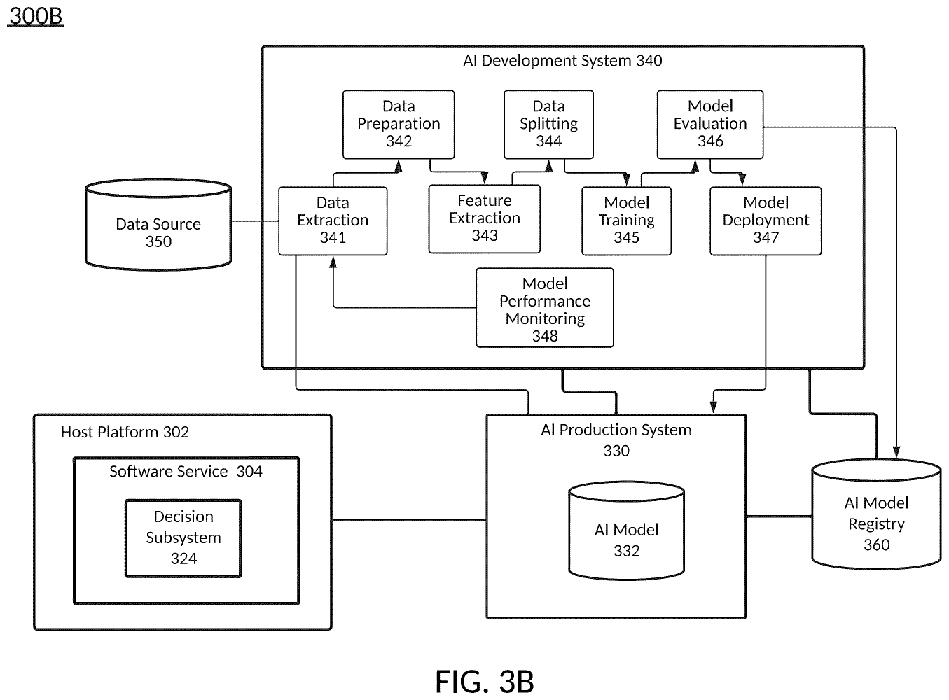

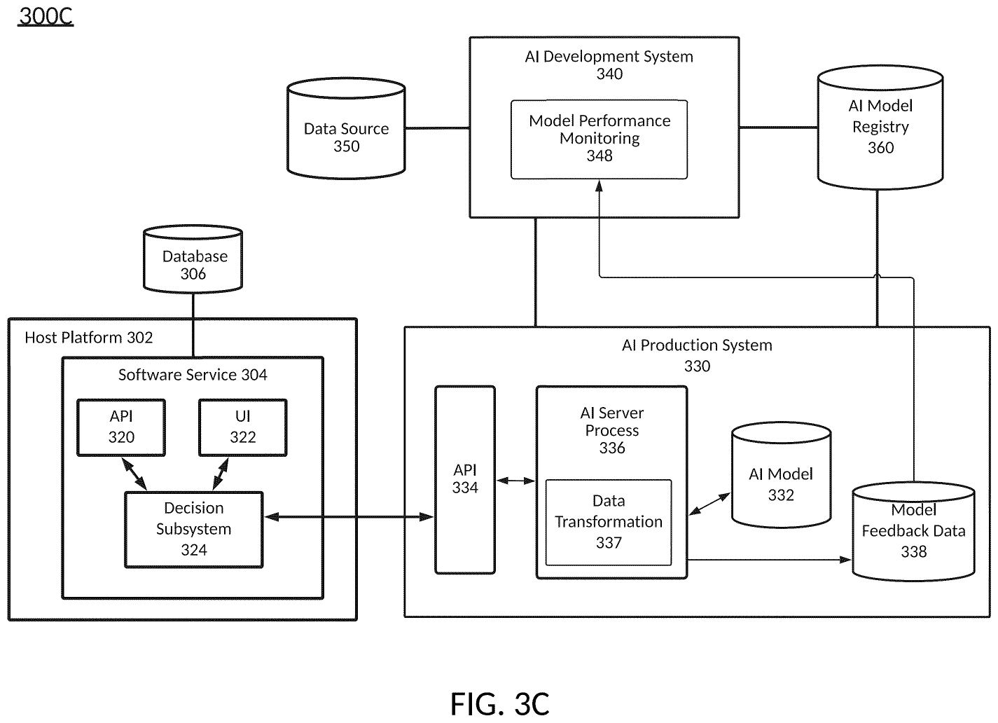

FIG. 3A illustrates an artificial intelligence (AI) network diagram 300A that supports AI-assisted decision points in a software service executing on a computer. As one example, the AI model being trained in the examples herein may refer to an LLM used for intent classification and/or slot filling in the example embodiments. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content—such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive one car, for example, and without too much effort, could learn how to drive other types of vehicles such as other cars, a truck, or a bus. The foundation model is similarly used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/ROBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized-broken down into smaller sequences of characters. These tokens are then transformed into embeddings, which are numeric representations of this context.

To ensure accuracy, this process involves training the LLM on a massive corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants (like IBM watsonx Assistant and Google's BARD) to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 304 (see FIG. 3A), executing on host platform 302 (see FIG. 3A) may provide one or more application programming interfaces (APIs) 320 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 320 send data to one or more decision subsystems 324 of the software service 304 to assist in decision-making. In some examples and features of the instant solution, the software service 304 stores data included in API requests or data generated during processing the API requests into one or more databases 306 (see FIGS. 1, 3A).

Software service 304 may provide one or more user interfaces (UIs) 322, such as a server-side hosted graphical user interface (GUI). In some examples and features of the instant solution, the UIs 322 provided employ template-based frameworks, component-based frameworks, etc. In some examples and features of the instant solution, these UIs 322 send data to one or more decision subsystems 324 of the software service 304 to assist with decision-making. In some examples and features of the instant solution, the software service 304 stores data included in UI requests or data generated during processing the UI requests into one or more databases 306.

Software service 304 may include one or more decision subsystems 324 that drive a decision-making process of the software service 304. In some examples and features of the instant solution, the decision subsystems 324 receive data from one or more APIs 320 as input into the decision-making process. In some examples and features of the instant solution, a decision subsystem 324 may receive data from one or more UIs 322 as input to the decision-making process. A decision subsystem 324 may gather service configuration or historical execution data from one or more databases 306 to aid in the decision-making process. A decision subsystem 324 may provide feedback to an API 320 or a UI 322.

An AI production system 330 may be used by a decision subsystem 324 in a software service 304 to assist in its decision-making process. The AI production system 330 includes one or more AI models 332 that are executed to generate a response, such as, but not limited to, a prediction, a categorization, a UI prompt, etc. In some examples and features of the instant solution, an AI production system 330 is hosted on a server. In some examples and features of the instant solution, the AI production system 330 is cloud hosted. In some examples and features of the instant solution, the AI production system 330 is deployed in a distributed multi-node architecture.

An AI development system 340 creates one or more AI models 332. In some examples and features of the instant solution, the AI development system 340 utilizes data from one or more data sources 350 to develop and train one or more AI models 332 according to the examples shown and described with respect to FIG. 2A-2C. The data sources 350 may be local or third-party data sources. Further, the data provided by the data sources may be real-world or synthetic. In some examples and features of the instant solution, the AI development system 340 utilizes feedback data from one or more AI production systems 330 for new model development and/or existing model re-training. In some examples and features of the instant solution, the AI development system 340 resides and executes on a server. In some examples and features of the instant solution, the AI development system 340 is cloud hosted. In some examples and features of the instant solution, the AI development system 340 is deployed in a distributed multi-node architecture. In some examples and features of the instant solution, the AI development system 340 utilizes a distributed data pipeline/analytics engine.

Once an AI model 332 has been trained and validated in the AI development system 340, it may be stored in an AI model registry 360 for retrieval by either the AI development system 340 or by one or more AI production systems 330. The AI model registry 360 resides in a dedicated server in one example of the instant solution. In some examples and features of the instant solution, the AI model registry 360 is cloud hosted. In some examples and features of the instant solution, the AI model registry 360 resides in the AI production system 330. In some examples and features of the instant solution, the AI model registry 360 is a distributed database.

FIG. 3B illustrates a process 300B for developing one or more AI models that support AI-assisted decision points. An AI development system 340 executes steps to develop an AI model 332 that begins with data extraction 341, in which data is loaded and ingested from one or more data sources 350. In some examples and features of the instant solution, historical model feedback data is extracted from one or more AI production systems 330.

Once the data has been extracted during data extraction 341, it undergoes data preparation 342 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 342 may be a manual process or an automated process using one or more of the elements and/or functions described and/or depicted herein.

Features of the data are identified and extracted during the feature extraction step 343. In some examples and features of the instant solution, a feature of the data is internal to the prepared data from the data preparation step 342. In some examples and features of the instant solution, a feature of the data requires a piece of prepared data from the data preparation step 342 to be enriched by data from another data source to be useful in developing the AI model 332. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 332.

The dataset output from the feature extraction step 343 is split 344 into a training and validation data set. The training data set is used to train the AI model 332, and the validation data set is used to evaluate the performance of the AI model 332 on unseen data.

The AI model 332 is trained and tuned 345 using the training data set from the data splitting step 344. In this step, the training data set is provided to an AI algorithm and an initial set of algorithm parameters which may be automatically determined based on the interdependence between the relevant attributes determined according to various embodiments. The performance of the AI model 332 is then tested within the AI development system 340 utilizing the validation data set from step 344. These steps may be repeated with adjustments to one or more algorithm parameters until the model's performance is acceptable based on various goals and/or results.

The AI model 332 is evaluated 346 in a staging environment (not shown) that resembles the target AI production system 330. This evaluation uses a validation dataset to ensure the performance in an AI production system 330 matches or exceeds expectations. In some examples and features of the instant solution, the validation dataset from step 344 is used. In some examples and features of the instant solution, one or more unseen validation datasets are used. In some examples and features of the instant solution, the staging environment is part of the AI development system 340, and the staging environment is managed separately from the AI development system 340. Once the AI model 332 has been validated, it is stored in an AI model registry 360, where it can be retrieved for deployment and future updates. In some examples and features of the instant solution, the model evaluation step 346 may be a manual process or an automated process using one or more of the elements and/or functions described and/or depicted herein.

In some examples and features of the instant solution, the AI development system includes a user interface (not shown). The user interface may be used to manage the development system infrastructure, the steps 341-348 within the development system, the interim data transmitted between the various steps 341-348, and the data sources 350.

Once an AI model 332 has been validated and published to an AI model registry 360, it may be deployed during the model deployment step 347 to one or more AI production systems 330. In some examples and features of the instant solution, the performance of deployed AI model 332 is monitored 348 by the AI development system 340. In some examples and features of the instant solution, AI model 332 feedback data is provided by the AI production system 330 to enable model performance monitoring 348, and the AI development system 340 periodically requests feedback data for model performance monitoring 348, which includes one or more triggers that result in the AI model 332 being updated by repeating steps 341-348 with updated data from one or more data sources 350.

FIG. 3C illustrates a process 300C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 3C, an AI production system 330 may be used by a decision subsystem 324 in software service 304 to assist in its decision-making process. The AI production system 330 provides an API 334, executed by an AI server process 336 through which requests can be made. In some examples and features of the instant solution, a request may include an AI model 332 identifier to be executed based on the type of request. In some examples and features of the instant solution, a data payload (e.g., to be input to the AI model during execution) is included in the request. The data payload may include API 320 data from software service 304, UI 322 data from software service 304 or data from other software service 304 subsystems (not shown).

Upon receiving the API 334 request, the AI server process 336 may transform 337 the data payload or portions of the data payload to be valid feature values in an AI model 332. Data transformation 337 may include, but is not limited to, combining data values, normalizing data values, and enriching the incoming data with data from other data sources 350. Once the data transformation occurs, the AI server process 336 executes the appropriate AI model 332 using the transformed input data. Upon receiving the execution result, the AI server process 336 responds to the API requester, which is a decision subsystem 324 of software service 304. In some examples and features of the instant solution, the response may result in an update to a UI 322 in software service 304. In some examples and features of the instant solution, the response includes a request identifier that can be used later by the software service 304 to provide feedback on the performance of the AI model 332. In some examples and features of the instant solution, a model feedback record may be added into a model feedback data 338 by the AI server process 336.

In some examples and features of the instant solution, the API 334 includes an interface to provide AI model 332 feedback after an AI model 332 execution response has been processed. This mechanism enables the requester to provide feedback on the accuracy of the AI model 332 results. In some examples and features of the instant solution, the feedback interface includes the identifier of the initial request so that it can be used to associate the feedback with the request. Upon receiving a call into the feedback interface of the API 334, the AI server process 336 creates and adds a model feedback record into the model feedback data 338 which holds historical model feedback records. In some examples and features of the instant solution, the records in this model feedback data 338 are provided to model performance monitoring 348 in the AI development system 340. This model feedback data is streamed to the AI development system 340 or may be provided upon request. In some examples and features of the instant solution, the model feedback records in the model feedback data 338 are used as an input for retraining the AI model 332.

In some examples and features of the instant solution, the AI production system 330 includes a user interface (not shown). The user interface may be used to manage the production system infrastructure, the components of the production system 330-338, and the operation of the AI production system and its components.

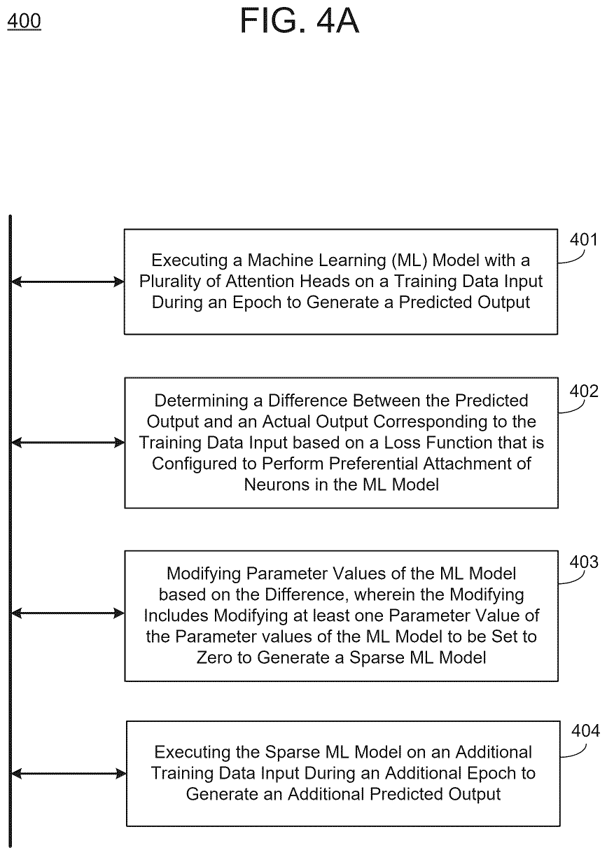

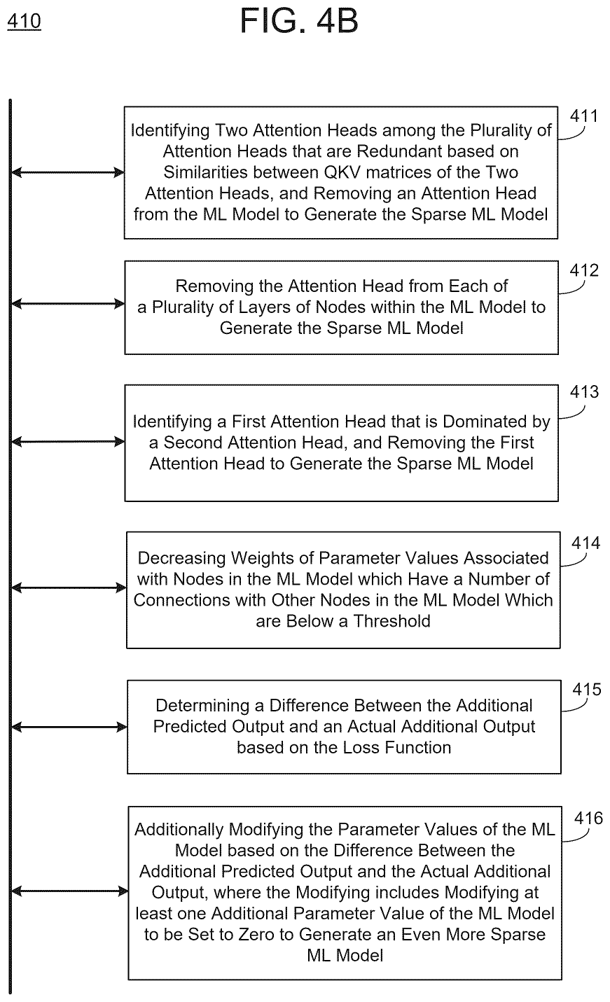

FIG. 4A illustrates a flow diagram of a method 400, according to example embodiments. Referring to FIG. 4A, in 401, the method may include executing a machine learning (ML) model with a plurality of attention heads on a training data input during an epoch to generate a predicted output. In 402, the method may include determining a difference between the predicted output and an actual output corresponding to the training data input based on a loss function that is configured to perform preferential attachment of neurons in the ML model. In 403, the method may include modifying parameter values of the ML model based on the difference, wherein the modifying comprises modifying at least one parameter value of the parameter values of the ML model to be set to zero to generate a sparse ML model. In 404, the method may include executing the sparse ML model on an additional training data input during an additional epoch to generate an additional predicted output.

FIG. 4B illustrates a flow diagram of a method 410, according to example embodiments. Referring to FIG. 4B, in 411, the method may include identifying two attention heads among the plurality of attention heads that are redundant based on similarities between Query, Key, Value (QKV) matrices of the two attention heads, and removing an attention head from among the two attention heads from the ML model to generate the sparse ML model. In 412, the method may include removing the attention head from each of a plurality of layers of nodes within the ML model to generate the sparse ML model. In 413, the method may include identifying a first attention head that is dominated by a second attention head, and the removing comprises removing the first attention head to generate the sparse ML model.

In 414, the modifying may include decreasing weights of parameter values associated with nodes in the ML model which have a number of connections with other nodes in the ML model which are below a threshold. In 415, the method may include determining a difference between the additional predicted output and an actual additional output based on the loss function. In 416, the method may include additionally modifying the parameter values of the ML model based on the difference between the additional predicted output and the actual additional output, wherein the modifying comprises modifying at least one additional parameter value of the ML model to be set to zero to generate an even more sparse ML model.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method comprising:
executing a machine learning (ML) model comprising multiple attention heads on training data during an epoch to generate a prediction;
determining a difference between the prediction and a ground truth value corresponding to the training data based on a loss function that is configured to perform preferential attachment of neurons in the ML model;
modifying parameter values of the ML model based on the difference, wherein the modifying comprises modifying at least one parameter value of the parameter values of the ML model to be set to zero to generate a sparse ML model; and
executing the sparse ML model on additional training data during an additional epoch to generate an additional prediction.

2. The computer-implemented method of claim 1, further comprising identifying two attention heads among the multiple attention heads that are redundant based on similarities between Query, Key, and Value matrices of the two attention heads, and removing an attention head from among the two attention heads from the ML model to generate the sparse ML model.

3. The computer-implemented method of claim 2, wherein the removing comprises removing the attention head from each of multiple layers of nodes within the ML model to generate the sparse ML model.

4. The computer-implemented method of claim 2, wherein the identifying comprises identifying a first attention head that is dominated by a second attention head, and the removing comprises removing the first attention head to generate the sparse ML model.

5. The computer-implemented method of claim 1, wherein the modifying comprises decreasing weights of parameter values associated with nodes in the ML model which have a number of connections with other nodes in the ML model which are below a threshold value.

6. The computer-implemented method of claim 1, further comprising determining a difference between the additional prediction and a further ground truth value corresponding to the additional training data based on the loss function.

7. The computer-implemented method of claim 6, further comprising additionally modifying the parameter values of the ML model based on the difference between the additional prediction and the further ground truth value, wherein the modifying comprises modifying at least one additional parameter value of the ML model to be set to zero to generate a more sparse ML model.

8. A computer system comprising:
a processor set;
a set of one or more computer-readable storage media; and
program instructions, collectively stored in the set of one or more storage media, for that causes the processor set to perform computer operations comprising:
execute a machine learning (ML) model comprising multiple attention heads on training data during an epoch to generate a prediction;
determine a difference between the prediction and a ground truth value that corresponds to the training data based on a loss function that is configured to perform preferential attachment of neurons in the ML model;
modify parameter values of the ML model based on the difference, wherein the modifying comprises applying a weighted penalty to at least one parameter value of a node of the ML model to generate a sparse ML model, the weighted penalty being inversely proportional to a fractional connectivity of the node to an associated node; and
execute the sparse ML model on additional training data during an additional epoch to generate an additional prediction.

9. The computer system of claim 8, wherein the computer operations further comprise identifying two attention heads among the multiple attention heads that are redundant based on similarities between Query, Key, and Value matrices of the two attention heads, and removing an attention head from among the two attention heads from the ML model to generate the sparse ML model.

10. The computer system of claim 9, wherein the removing comprises removing the attention head from each of multiple layers of nodes within the ML model to generate the sparse ML model.

11. The computer system of claim 9, wherein the identifying comprises identifying a first attention head that is dominated by a second attention head, and the removing comprises removing the first attention head to generate the sparse ML model.

12. The computer system of claim 8, wherein the modifying comprises decreasing weights of parameter values associated with nodes in the ML model which have a number of connections with other nodes in the ML model which are below a threshold value.

13. The computer system of claim 8, wherein the computer operations further comprise determining a difference between the additional prediction and a further ground truth value corresponding to the additional training data based on the loss function.

14. The computer system of claim 13, wherein the computer operations further comprise additionally modifying the parameter values of the ML model based on the difference between the additional prediction and the further ground truth value, wherein the modifying comprises modifying at least one additional parameter value of the ML model to be set to zero to generate a more sparse ML model.

15. A computer program product comprising:
a set of one or more computer-readable storage media; and
program instructions, collectively stored in the set of one or more computer-readable storage media, for causing a processor set to perform computer operations comprising:
executing a machine learning (ML) model comprising multiple attention heads on training data during an epoch to generate a prediction;
determining a difference between the prediction and a ground truth value corresponding to the training data based on a loss function that is configured to perform preferential attachment of neurons in the ML model;
modifying parameter values of the ML model based on the difference, wherein the modifying comprises modifying at least one parameter value of the parameter values of the ML model to be set to zero to generate a sparse ML model; and
executing the sparse ML model on an additional training data during an additional epoch to generate an additional prediction.

16. The computer system of claim 8, wherein the computer operations further comprise identifying two attention heads among the multiple attention heads that are redundant based on similarities between Query, Key, and Value matrices of the two attention heads, and removing an attention head from among the two attention heads from the ML model to generate the sparse ML model.

17. The computer system of claim 9, wherein the removing comprises removing the attention head from each of multiple layers of nodes within the ML model to generate the sparse ML model.

18. The computer system of claim 9, wherein the identifying comprises identifying a first attention head that is dominated by a second attention head, and the removing comprises removing the first attention head to generate the sparse ML model.

19. The computer system of claim 8, wherein the modifying comprises decreasing weights of parameter values associated with nodes in the ML model which have a number of connections with other nodes in the ML model which are below a threshold.

20. The computer system of claim 8, wherein the computer operations further comprise determining a difference between the additional prediction and a further ground truth value corresponding to the additional training data based on the loss function, and additionally modifying the parameter values of the ML model based on the difference between the additional prediction and the further ground truth value, wherein the modifying comprises modifying at least one additional parameter value of the ML model to be set to zero to generate a more sparse ML model.
